(19) United States
(12) Patent Application Publication
(10) Pub. No.: US 2026/0057858 A1
(43) Pub. Date: Feb. 26, 2026

(54) DRUM PEDAL BEATER HAVING SWITCHABLE STRIKING SURFACES

(71) Applicant: K.H.S. MUSICAL INSTRUMENT CO., LTD., New Taipei City (TW)

(72) Inventor: Chun-Hsing CHEN, New Taipei City (TW)

(73) Assignee: K.H.S. MUSICAL INSTRUMENT CO., LTD., New Taipei City (TW)

(21) Appl. No.: 18/810,267

(22) Filed: Aug. 20, 2024

(51) Int. Cl. G10D 13/11

(52) U.S. Cl. CPC G10D 13/11

(57) ABSTRACT

A drum pedal beater having switchable striking surfaces includes a beater head internally provided with a mounting space, an insertion passage communicable with the mounting space, and a swing passage located adjacent to the mounting space and the insertion passage; a beater shaft connected at an end to the beater head and swingable in the swing passage between an initial position and a striking position near a drum top head; and a steering member accommodated in the mounting space. The beater head is swingable relative to the steering member while the beater shaft is swinging in the swing passage. The beater head has a preliminary striking surface and a first striking surface, both of which can be moved into the striking position and located in parallel with the drum top head. When the beater head swings relative to the steering member, the beater head are switchable between the preliminary striking surface and the first striking surface to change the striking surface quickly.

### FIELD OF THE INVENTION

The present invention relates to a drum pedal beater mounted on a drum pedal assembly, and more particularly, to a drum pedal beater including multiple switchable striking surfaces and the striking surfaces on the drum pedal beater can be changed quickly.

### BACKGROUND OF THE INVENTION

A drum kit is a collection of drums of different timbres and other percussion instruments. In most cases, the drum kit consists of a bass drum, a snare drum, a tom drum, a floor drum, a China cymbal, a hi-hat, and a bass drum pedal. The China cymbal can be further divided into crash cymbal, ride cymbal, trash cymbal, and splash cymbal. The bass drum is also referred to as a kick drum, and is usually 18′, 20′, 22′, 24′ or 26′ in diameter and 14′ or 18′ in depth. In most cases, the bass drum is operated with a foot pedal, which drives a mallet or beater to hit the drum top head to produce a relatively deep timbre. A drum player can kick a footboard of the foot pedal to produce musical sound.

The beaters can be generally divided into three major categories, namely, cotton felt beater, plastic beater, and wooden beater. The cotton felt beater can be made of wool felt for direct contacting with the drum top head to produce a mild timbre suitable for soft genre. The plastic beater has an obviously grainy surface and the direct contact of the plastic beater with the drum top heat will produce a high-frequency timbre suitable for quick tempo genre. The wooden beater in direct contact with the drum top head can produce a rich timbre suitable for most genres. When the drum player wants to perform an exactly different musical genre, he must take time to remove the original beater from the foot pedal and connect another beater of a desired material to the foot pedal. This is of course troublesome and time consuming to do so.

When the beater is driven to contact with the drum top head, the surface of the beater might not be in full contact with the drum top head and the timbre of the sound produced by each striking of the beater is different from those produced by other strikes. This condition would adversely influence the accuracy of the music being played.

### SUMMARY OF THE INVENTION

A primary object of the present invention is to provide a drum pedal beater having switchable striking surfaces, a beater head of which is rotatable in at least one axial direction to quickly change to a desired one of the striking surfaces.

Another object of the present invention is to provide the above drum pedal beater having switchable striking surfaces, and the striking surfaces are formed of different materials and have different contact areas, such that many different musical timbres can be produced by striking a drum top head with only one single beater head, and a drum player may choose freely a desired striking surface on the beater head to produce a corresponding timbre.

A further object of the present invention is to provide the above drum pedal beater having switchable striking surfaces, and the beater head thereof is not immovably connected to a beater shaft. When the beater head is in contact with the drum top head, the striking surface that is initially located obliquely relative to the drum top head can be rotated pivotally automatically to be located in parallel with the drum top head, allowing the striking surface to fully contact with the drum top head.

To achieve the above and other objects, the drum pedal beater having switchable striking surfaces according to the present invention is mounted on a drum pedal assembly controllable with a drum player's foot. The drum pedal beater includes a beater head, a beater shaft, and a steering member. The beater head internally includes a mounting space, an insertion passage communicable with the mounting space, and a swing passage located adjacent to the mounting space and the insertion passage. A surface of the beater head forms a preliminary striking surface extending in a transverse direction and an another surface of the beater head forms a first striking surface extending in a longitudinal direction.

The beater shaft having a first end and a second end located at two opposite sides in an axial direction. The first end is inserted into the insertion passage of the beater head and the second end is connected to a pivotal section of the drum pedal assembly. The first end of the beater shaft is drivable via the drum pedal assembly to swing between an initial position located farther away from a drum top head and a striking position for touching the drum top head.

The steering member is accommodated in the mounting space of the beater head and connected to the first end of the beater shaft, such that the beater head is swingable relative to the steering member while the beater shaft is movable in the swing passage. When the beater head swings relative to the steering member, the beater head is switchable from the preliminary striking surface to the first striking surface for striking the drum top head.

A second striking surface further being formed on other surface of the beater head extending in the transverse direction. The preliminary striking surface and the second striking surface are configured as a first planar surface and a second planar surface, respectively; and the first striking surface is a generally hemispherical curved surface. The preliminary striking surface and the second striking surface are located at two opposite sides of the beater head, and the swing passage is extended to occupy a partial area of the second planar surface, so that the second planar surface is in the shape of an inverted U letter.

The first planar surface has a first round area and the second planar surface has a second round area smaller than the first round area. The first planar surface is formed of a piece of wool felt, and the second planar surface and the hemispherical curved surface are formed of a plastic material.

The beater shaft is rotatably connected to the steering member, so that the steering member and the beater head are rotatable simultaneously in the axial direction relative to the beater shaft, and the beater head is capable of being switched from the preliminary striking surface to the second striking surface for striking the drum top head.

The steering member includes a hollow cylinder configured corresponding to the mounting space and a pressing member. The hollow cylinder has a through bore for being inserted by the beater shaft and a locking hole communicating with the through bore, the pressing member is screwed in the locking hole, so that the beater shaft is capable of being clamped or released by the pressing member in the through bore. A loose-fit connection is formed between the beater head and the steering member, so that an angular position of the beater head is capable of being adjusted automatically when one of the preliminary striking surface and the second striking surface is used to strike the drum top head, and the preliminary striking surface or the second striking surface will be paralleled with the drum top head in the striking position.

The swing passage forms a sector contour. A part of the sector contour is extended forward from the insertion passage by a range between 5 to 15 degrees, while the remaining part of the sector contour is extended backward from the insertion passage by a range between 90 to 100 degrees.

The beater head further includes an adjusting gap located perpendicular to the swing passage to divide the beater head into a first clamping section and a second clamping section located at two opposite sides of the adjusting gap; and a compressing member provided between the first and the second clamping section for changing the adjusting gap and the mounting space to different sizes. The beater head also includes a first insertion hole formed on the first clamping section to extend in parallel with the adjusting gap, and a second insertion hole formed on between the first and the second clamping section to extend perpendicular to the adjusting gap and communicate with the first insertion hole and the adjusting gap. The compressing member includes a nut disposed in the first insertion hole and a screw extended through the second insertion hole to mesh with the nut.

The drum pedal beater with switchable striking surfaces of the present invention is characterized in having the beater head, the beater shaft, and the steering member. The beater head internally includes the mounting space, the insertion passage, and the swing passage; and the mounting space communicates with the insertion passage, and the swing passage forms a sector contour. The first end of the beater shaft is inserted into the insertion passage and the second end of the beater shaft is mounted on the pivotal section of the drum pedal assembly, so that the first end of the beater shaft is drivable via the drum pedal assembly to swing between the initial position located farther away from a drum top head and the striking position for touching the drum top head. A loose-fit connection is formed between the beater head and the steering member, and the steering member is movably connected to the first end of the beater shaft to be rotatable in the axial direction relative to the beater shaft. The steering member is accommodated in the mounting space of the beater head, and the beater head is swinging relative to the steering member while the beater shaft is moving in the swing passage. A surface of the beater head forms a preliminary striking surface extending in a transverse direction and an another surface of the beater head forms a first striking surface extending in a longitudinal direction. The preliminary striking surface and the second striking surface are configured as a first planar surface and a second planar surface, respectively; and the first striking surface is a generally hemispherical curved surface. The first planar surface is formed of a piece of wool felt, and the second planar surface and the hemispherical curved surface are formed of a plastic material. And, the preliminary striking surface and the second striking surface moved to the striking position are located in parallel with the drum top head. With the above arrangements, the beater head can be quickly switched among different striking surfaces for striking the drum top head to produce different music timbres.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein

FIG. 1 shows a drum pedal beater having switchable striking surfaces according to a preferred embodiment of the present invention is mounted on a drum pedal assembly;

FIG. 2 is an assembled perspective view of the drum pedal beater having switchable striking surfaces according to the preferred embodiment of the present invention;

FIG. 3 is a partially sectioned exploded perspective view of FIG. 2;

FIG. 4 is a cutaway view showing how a beater head and a beater shaft of the drum pedal beater of the present invention are connected to each other;

FIG. 5 is a side view showing the beater head and the beater shaft and a steering member of the drum pedal beater of the present invention;

FIGS. 6A to 6C show the beater shaft is connected to a mounting space provided in the beater head;

FIG. 7 shows the drum pedal beater of the present invention when a preliminary striking surface on the beater head thereof is located in parallel with a drum top head;

FIG. 8 shows the drum pedal beater of the present invention when a first striking surface on the beater head thereof is located in parallel with the drum top head; and

FIG. 9 shows the drum pedal beater of the present invention when a second striking surface on the beater head thereof is located in parallel with the drum top head.

### DETAILED DESCRIPTION OF THE PREFERRED EMBODIMENTS

The present invention will now be described with a preferred embodiment thereof and by referring to the accompanying drawings.

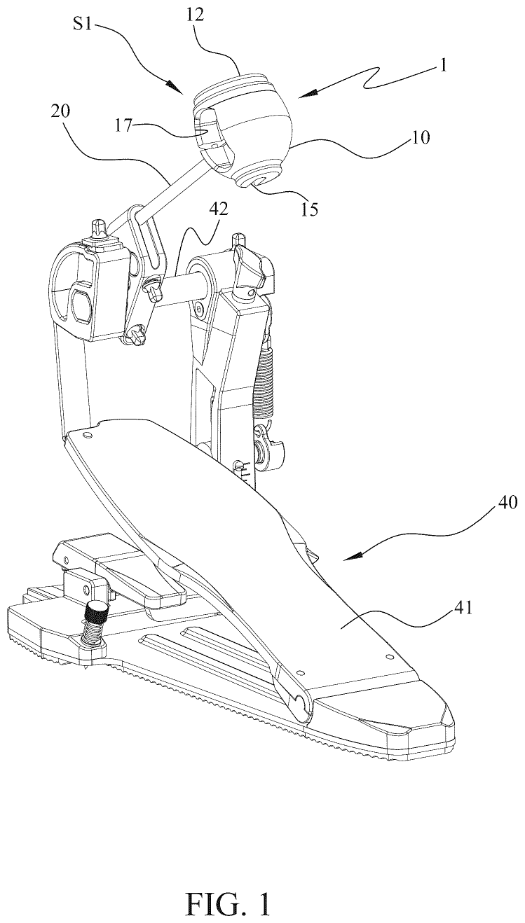

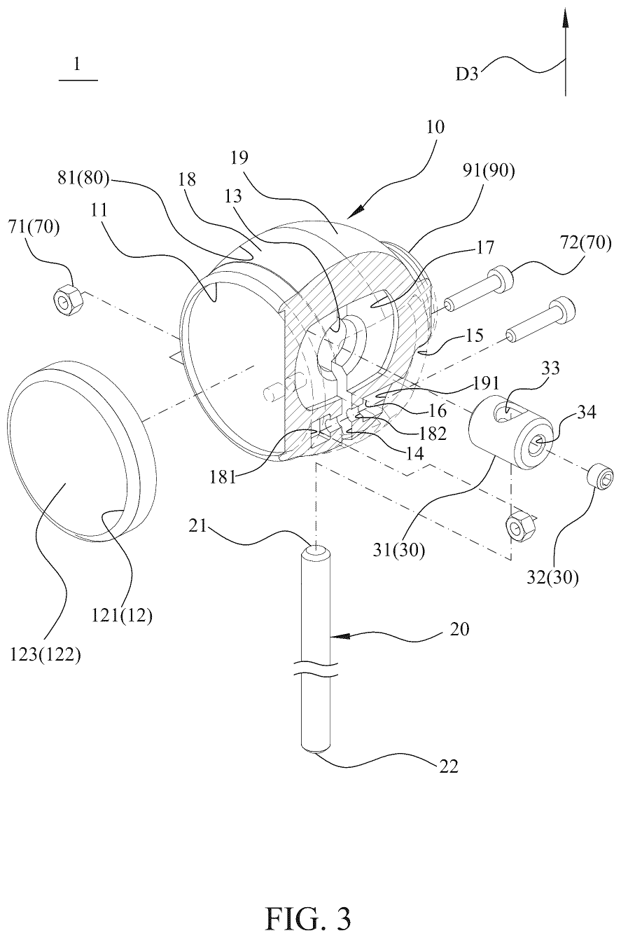

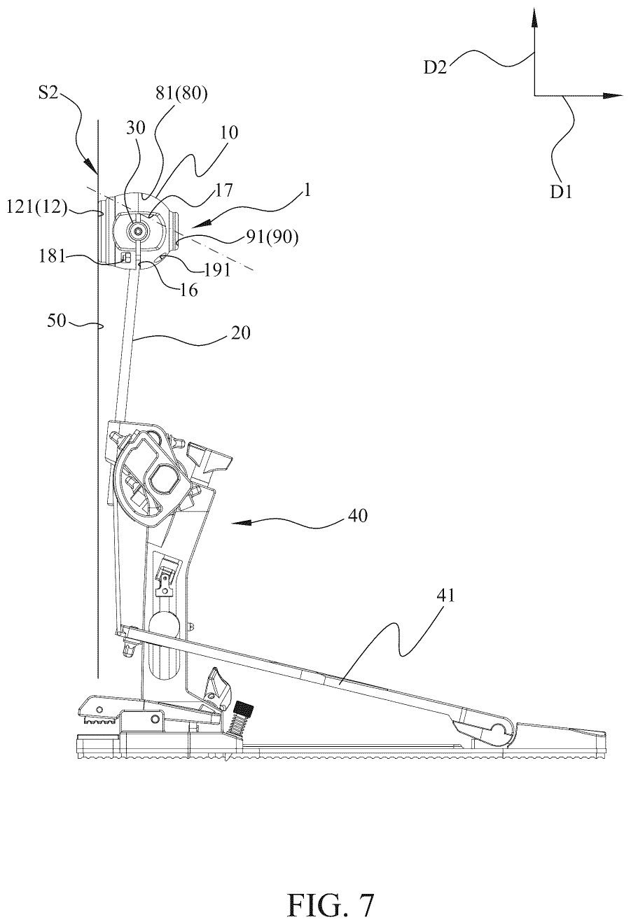

Please refer to FIGS. 1, 2, 3 and 7. A drum pedal beater 1 having switchable striking surfaces according to a preferred embodiment of the present invention mainly includes a beater head 10, a beater shaft 20, and a steering member 30. For the purpose of clarity and conciseness, the present invention is also briefly referred to as the drum pedal beater 1 herein and generally denoted by reference numeral 1. As shown, the beater head 10 is mounted on a drum pedal assembly 40, and a drum player can strike a drum top head 50 with the beater head 10 by kicking a footboard 41 of the drum pedal assembly 40.

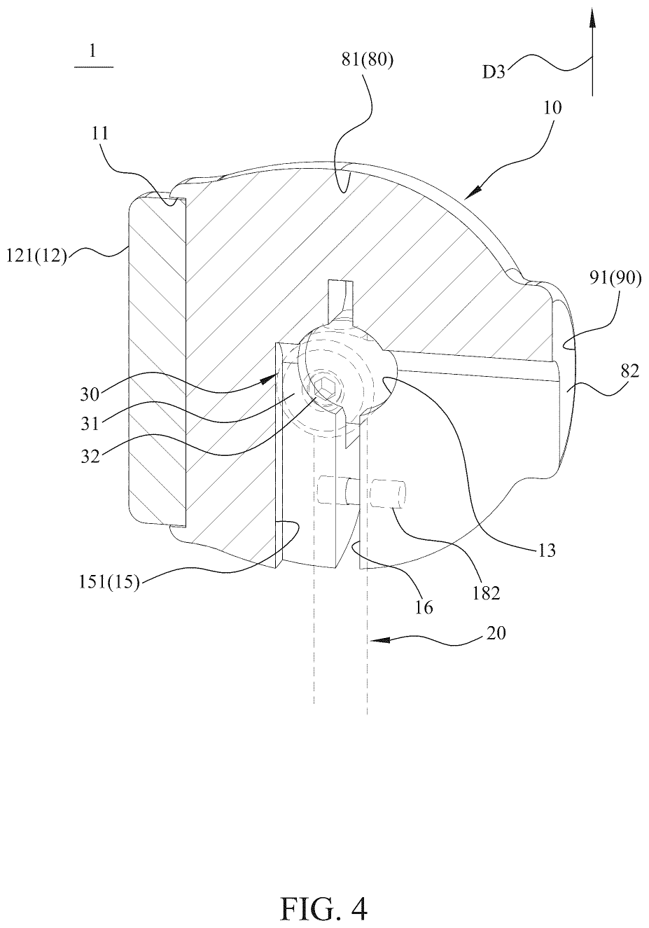

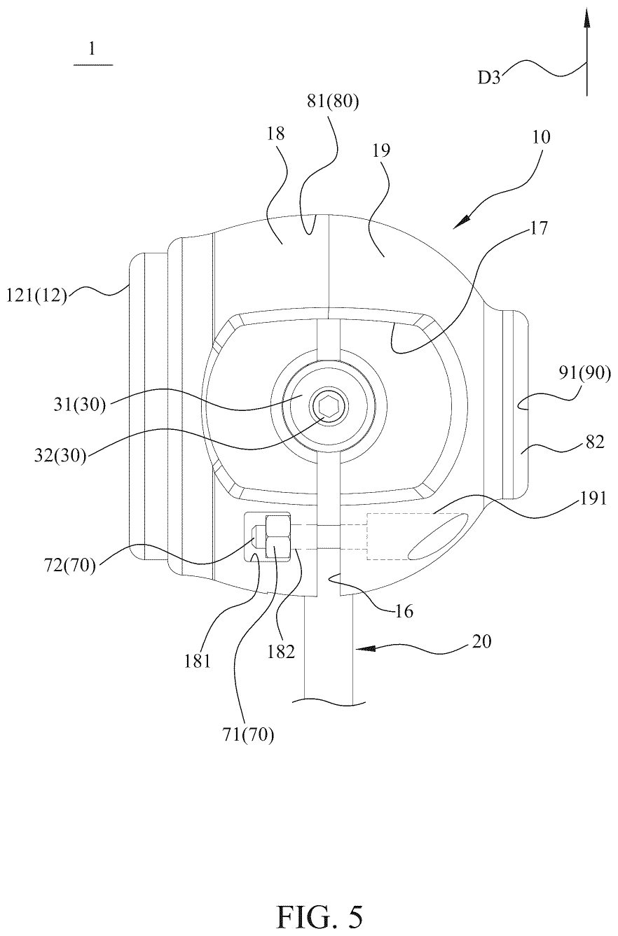

Please refer to FIGS. 1 to 5 and 7. The beater head 10 includes an opening 11, a preliminary striking surface 12, a mounting space 13, an insertion passage 14, a swing passage 15, an adjusting gap 16, and a recess 17. The preliminary striking surface 12 is formed on a local surface of the beater head 10 extended in a transverse direction D1, and a first striking surface 80 is formed on another local surface of the beater head 10 extended in a longitudinal direction D2. The preliminary striking surface 12 is in the form of a first planar surface 121 connected to the opening 11 and has a first round area 122. The insertion passage 14 is communicable with the mounting space 13, and the swing passage 15 is located in the vicinity of the mounting space 13 and the insertion passage 14 to extend toward the opening 11 and communicate with the insertion passage 14. In the illustrated preferred embodiment, the first planar surface 121 is formed of a piece of wool felt 123, which is movable to be in direct contact with the drum top head 50 to produce a relatively mild timbre suitable for gentle music genre.

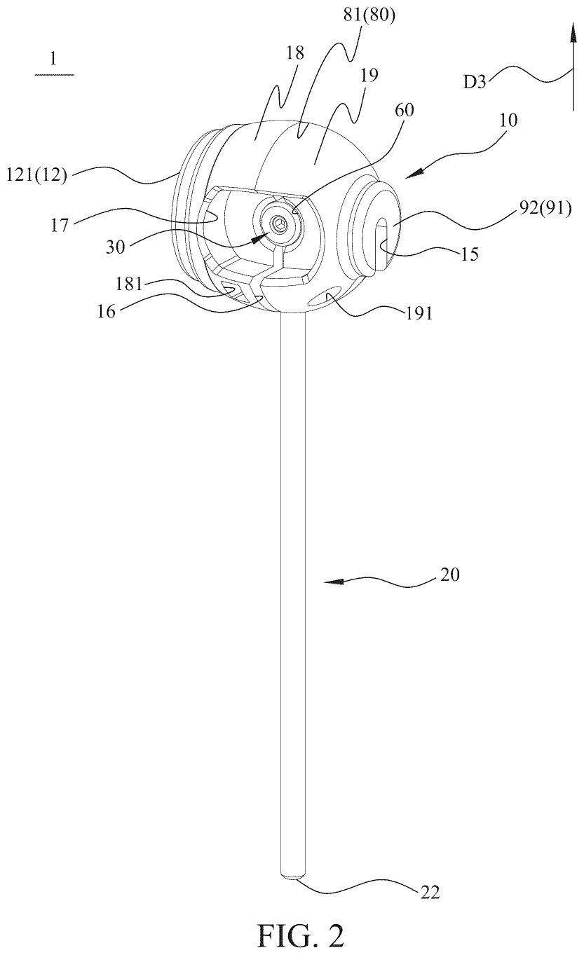

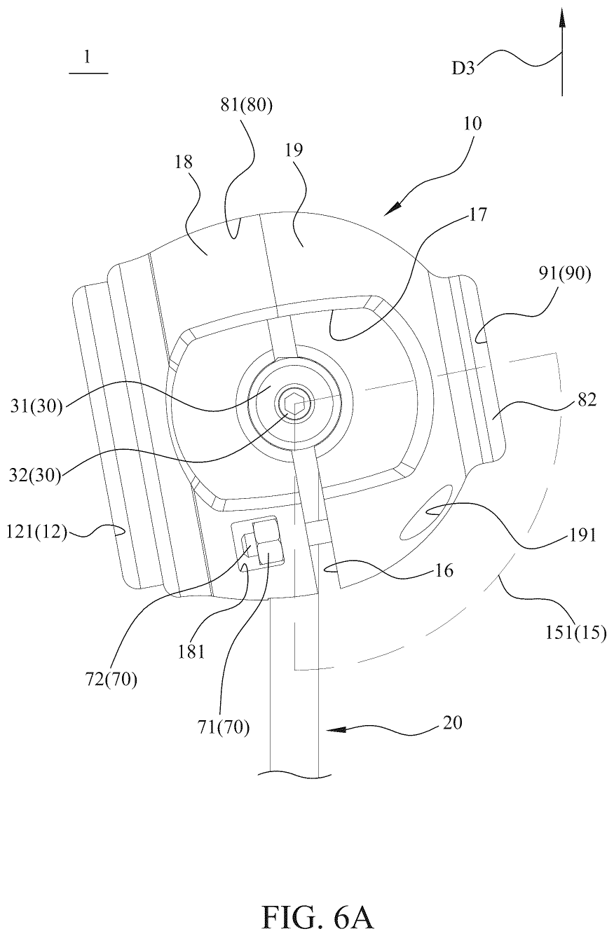

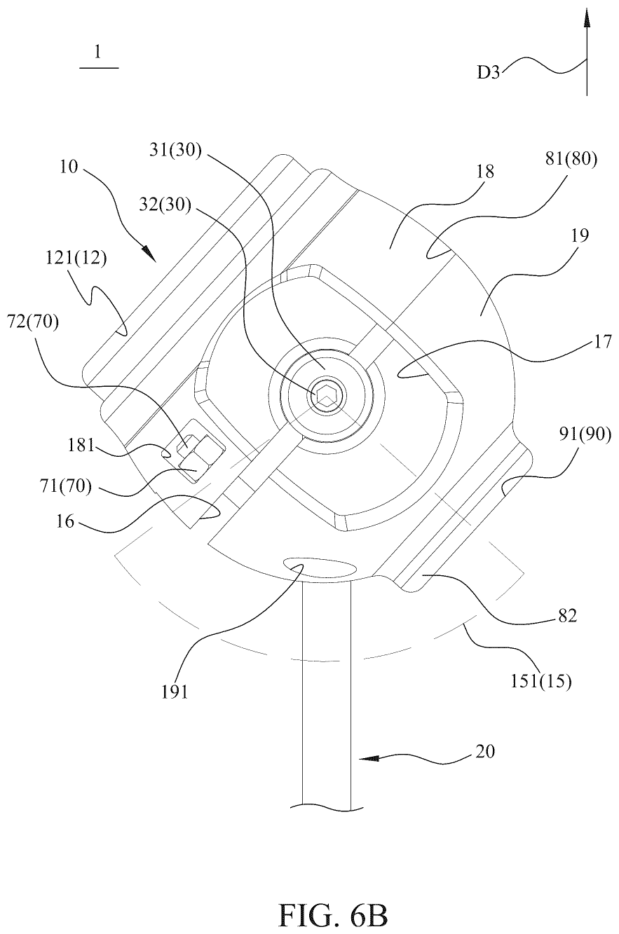

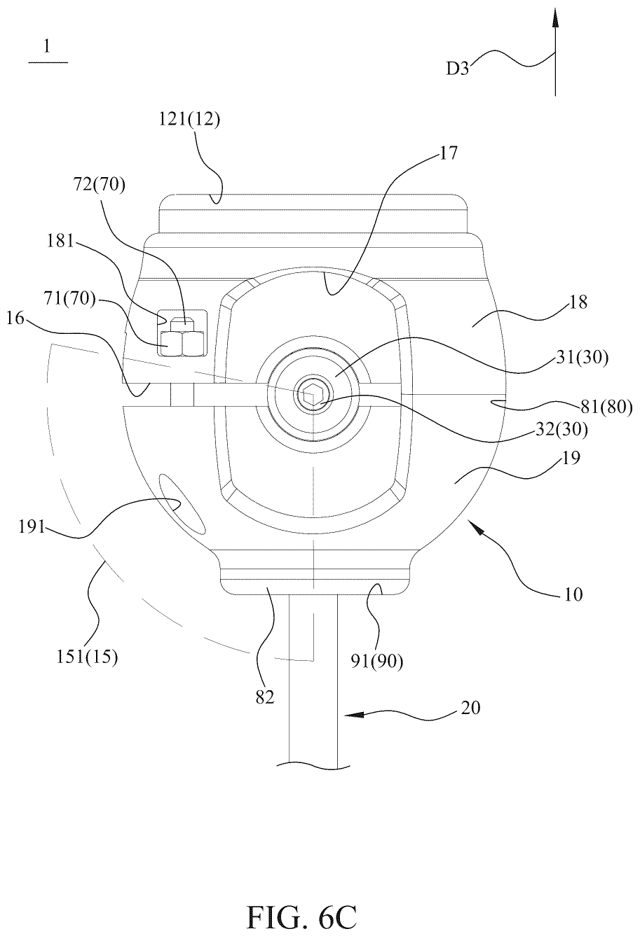

Please refer to FIGS. 2 to 4 and FIGS. 6A to 6C. The swing passage 15 is in the shape of a sector contour 151. A part of the sector contour 151 is extended forward from the insertion passage 14 by 5˜15 degrees, and the remaining part of the sector contour 151 is extended backward from the insertion passage 14 by 90˜100 degrees. The adjusting gap 16 is communicable with the insertion passage 14 and the swing passage 15 while being located perpendicular to the swing passage 15, such that the beater head 10 is divided by the adjusting gap 16 into a first clamping section 18 and a second clamping section 19 that are located at two opposite sides of the adjusting gap 16. The beater head 10 has a first insertion hole 181 formed on the first clamping section 18 to extend in parallel with the adjusting gap 16, a second insertion hole 182 formed between the first clamping section 18 and the second clamping section 19 to extend perpendicular to the adjusting gap 16, such that the second insertion hole 182 communicates with the first insertion hole 181, and a third insertion hole 191 formed on the second clamping section 19, such that the second insertion hole 182 is located between the first insertion hole 181 and the third insertion hole 191. The recess 17 is recessed from an outer surface of the beater head 10 and located adjacent to the opening 11. The recess 17 communicates with the mounting space 13, the insertion passage 14, and the adjusting gap 16 and is located adjacent to the mounting space 13 and the adjusting gap 16.

Please refer to FIGS. 1 to 3. The beater shaft 20 has a first end 21 and a second end 22, which are located at two opposite sides in an axial direction D3. The first end 21 is inserted into the insertion passage 14 on the beater head 10, and the second end 22 is connected to a pivotal section 42 on the drum pedal assembly 40, such that both the beater head 10 and the beater shaft 20 are located above the footboard 41.

Please refer to FIGS. 2 to 5. The steering member 30 is pushed into the beater head 10 via the recess 17 until the steering member 30 is accommodated in the mounting space 13 of the beater head 10, such that the steering member 30 and the beater head 10 form a loose-fit connection 60 between them. The steering member 30 includes a hollow cylinder 31 configured corresponding to the mounting space 13 and a pressing member 32. The hollow cylinder 31 has a through bore 33 formed thereon and defines an axial locking hole 34. The through bore 33 allows the beater shaft 20 to extend therethrough and the locking hole 34 allows the pressing element 32 to extend thereinto. The through bore 33 communicates with the locking hole 34, such that the pressing member 32 is movable away from or close to the first end 21 of the beater shaft 20.

Please refer to FIGS. 2 to 5. The first end 21 of the beater shaft 20 is extended in an axial direction D3 into the insertion passage 14 on the beater head 10 and the through bore 33 of the steering member 30, and the pressing element 32 is then screwed into the locking hole 34. The pressing element 32 may be moved toward the beater shaft 20 to clamp the first end 21 thereof in the through bore 33 or moved away from the beater shaft 20 to release the first end 21. A compressing member 70 is provided on between the first clamping section 18 and the second clamping section 19 for changing the size of the adjusting gap 16 and the mounting space 13. The compressing member 70 includes a nut 71 and a screw 72. The nut 71 is disposed in the first insertion hole 181 and the screw 72 is extended into the adjusting gap 16 via the third insertion hole 191 to pass through the second insertion hole 182 and enter into the first insertion hole 181. The screw 72 entered the second insertion hole 182 meshes with the nut 71 disposed in the first insertion hole 181 to move closer to each other. At this point, the first clamping section 18 is pushed by the nut 71 toward the second clamping section 19 while the second clamping section 19 is pushed by the screw 72 toward the first clamping section 18. Therefore, the adjusting gap 16 and the mounting space 13 are narrowed.

Please refer to FIGS. 1, 3, 4, 6A to 6C, and 7. The beater shaft 20 is held to the steering member 30 and the steering member 30 is movably mounted to the first end 21 of the beater shaft 20. The first end 21 of the beater shaft 20 is drivable via the drum pedal assembly 40 to swing between an initial position S1 and a striking position S2. In the initial position S1, the first end 21 of the beater shaft 20 is located farther away from the drum top head 50; and in the striking position S2, the first end 21 of the beater shaft 20 is located adjacent to the drum top head 50 and the preliminary striking surface 12 of the beater head 10 is allowed to contact with the drum top head 50. The steering member 30 is rotatable in the axial direction D3 relative to the beater shaft 20, the beater head 10 is swingable relative to the steering member 30, and the beater shaft 20 is movable in the swing passage 15. With these arrangements, the pressing member 32 and the compressing member 70 work corporately to hold the first end 21 of the beater shaft 20 in the beater head 10, the beater head 10 and the steering member 30 are movable in the axial direction D3 to swing relative to the beater shaft 20 clockwise or counterclockwise, and the beater head 10 is also swingable relative to the steering member 30.

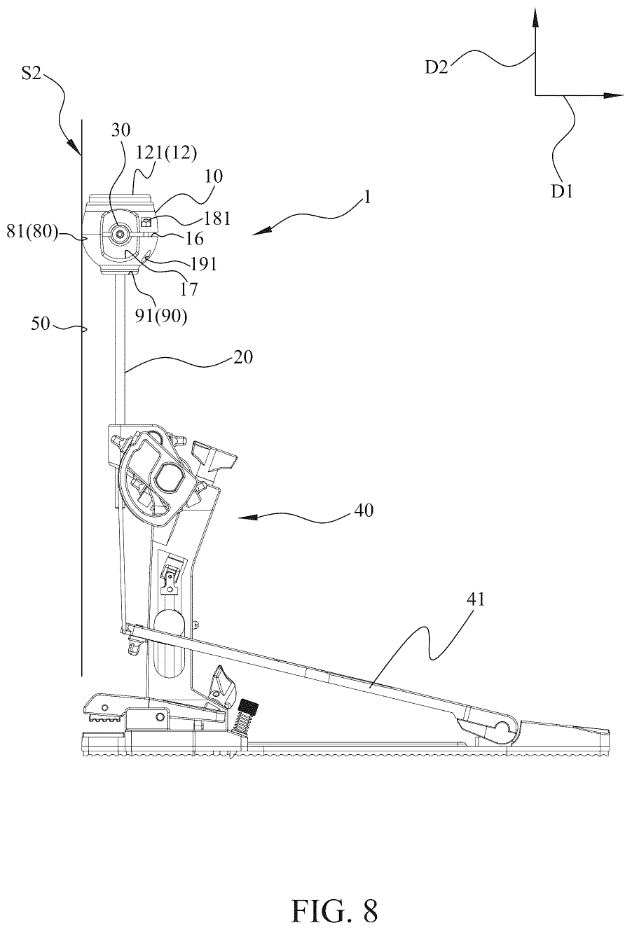

Please refer to FIGS. 2, 4, 6B, 6C, and 8. When the beater head 10 is rotated in the axial direction D3 clockwise or counterclockwise while swinging relative to the steering member 30, the preliminary striking surface 12 of the beater head 10 is movable away from the drum top head 50 and the first striking surface 80 is movable toward and contactable with the drum top head 50. As can be seen from the drawings, the first striking surface 80 is a generally hemispherical curved surface 81.

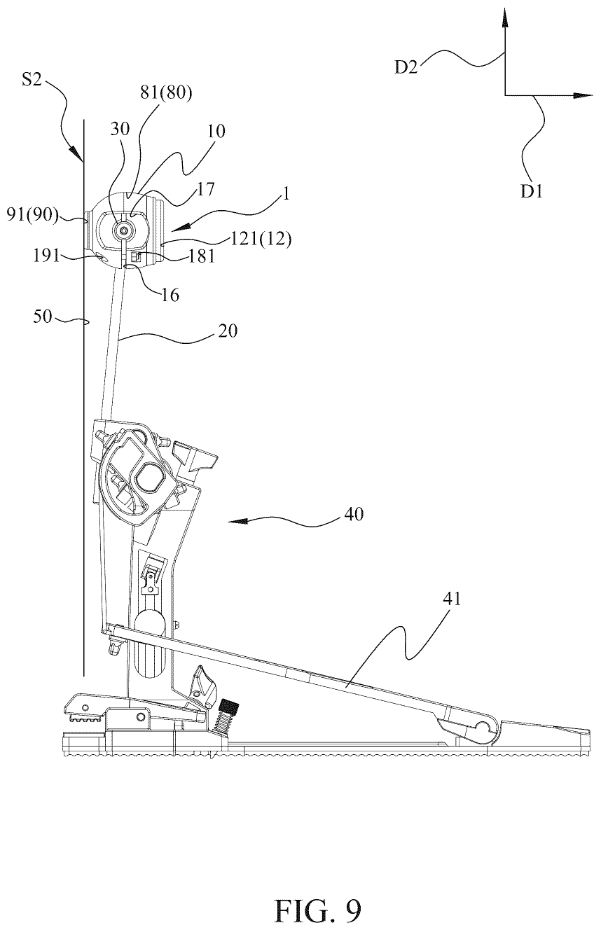

Please refer to FIGS. 2 to 5, 6A, 6B, 8, and 9. When the beater head 10 and the steering member 30 are rotated simultaneously in the axial direction D3 clockwise or counterclockwise, the beater head 10 and the steering member 30 can be rotated simultaneously relative to the beater shaft 20 for the preliminary striking surface 12 to move away from the drum top head 50. Meanwhile, the second striking surface 90 is movable toward and contactable with the drum top head 50. As can be seen from the drawings, the second striking surface 90 is a second planar surface 91 extended in parallel with the preliminary striking surface 12; the hemispherical curved surface 81 of the first striking surface 80 is located between the first planar surface 121 and the second planar surface 91; and the recess 17 is located between the preliminary striking surface 12 and the second striking surface 90. The second planar surface 91 has a second round area 92, which is smaller than the first round area 122. The swing passage 15 is extended from the second striking surface 90 toward the preliminary striking surface 12 to occupy a partial area of the second planar surface 91, so that the second planar surface 91 is in the shape of an inverted U letter. When any one of the preliminary striking surface 12 and the second striking surface 90 is used to strike the drum top head 50, the beater shaft 20 will swing in the sector contour 151 of the swing passage 15, and the steering member 30 can approach the drum top head 50 either by rotating forward by 10 degrees in the axial direction D3 relative to the beater shaft 20 or rotating backward by 90 degrees in the axial direction D3 relative to the beater shaft 20. That is, any one of the preliminary striking surface 12 and the second striking surface 90 can be angularly adjusted to be in parallel with the drum top head 50. Therefore, either the preliminary striking surface 12 or the second striking surface 90 can be in fully flat contact with the drum top head 50. Further, there is not particular limit to the angle by which the steering member 30 is rotated relative to the beater shaft 20. The steering member 30 can be rotated in the axial direction between a range of 10-degree forward and 90-degree backward. The second planar surface 91 and the hemispherical curved surface 81 are formed of a plastic material 82, which can be moved to contact with the drum top head 50 directly to produce a high-frequency timbre suitable for music genre of quick tempo.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A drum pedal beater having switchable striking surfaces and mounted on a drum pedal assembly, comprising:
a beater head internally including a mounting space, an insertion passage communicable with the mounting space, and a swing passage located adjacent to the mounting space and the insertion passage; and a surface of the beater head forms a preliminary striking surface extending in a transverse direction and an another surface of the beater head forms a first striking surface extending in a longitudinal direction;
a beater shaft having a first end and a second end located at two opposite sides in an axial direction; the first end being inserted into the insertion passage of the beater head and the second end being connected to a pivotal section of the drum pedal assembly; and the first end of the beater shaft being drivable via the drum pedal assembly to swing between an initial position located farther away from a drum top head and a striking position for touching the drum top head; and
a steering member being accommodated in the mounting space of the beater head and connected to the first end of the beater shaft, such that the beater head is swingable relative to the steering member while the beater shaft is movable in the swing passage; and
wherein, when the beater head swings relative to the steering member, the beater head is switchable from the preliminary striking surface to the first striking surface for striking the drum top head.

2. The drum pedal beater having switchable striking surfaces as claimed in claim 1, wherein a second striking surface further being formed on other surface of the beater head extending in the transverse direction; the preliminary striking surface and the second striking surface being configured as a first planar surface and a second planar surface, respectively; and the first striking surface being a generally hemispherical curved surface.

3. The drum pedal beater having switchable striking surfaces as claimed in claim 2, wherein the preliminary striking surface and the second striking surface are located at two opposite sides of the beater head, and the swing passage being extended to occupy a partial area of the second planar surface, so that the second planar surface is in the shape of an inverted U letter.

4. The drum pedal beater having switchable striking surfaces as claimed in claim 2, wherein the first planar surface has a first round area and the second planar surface has a second round area smaller than the first round area; and the first planar surface being formed of a piece of wool felt, and the second planar surface and the hemispherical curved surface being formed of a plastic material.

5. The drum pedal beater having switchable striking surfaces as claimed in claim 2, wherein the beater shaft is rotatably connected to the steering member, so that the steering member and the beater head being rotatable simultaneously in the axial direction relative to the beater shaft, and the beater head is capable of being switched from the preliminary striking surface to the second striking surface for striking the drum top head.

6. The drum pedal beater having switchable striking surfaces as claimed in claim 5, wherein the steering member includes a hollow cylinder configured corresponding to the mounting space and a pressing member; the hollow cylinder having a through bore for being inserted by the beater shaft and a locking hole communicating with the through bore, the pressing member is screwed in the locking hole, so that the beater shaft is capable of being clamped or released by the pressing member in the through bore.

7. The drum pedal beater having switchable striking surfaces as claimed in claim 5, wherein a loose-fit connection is formed between the beater head and the steering member, so that an angular position of the beater head is capable of being adjusted automatically when one of the preliminary striking surface and the second striking surface is used to strike the drum top head, and the preliminary striking surface or the second striking surface will be paralleled with the drum top head in the striking position.

8. The drum pedal beater having switchable striking surfaces as claimed in claim 1, wherein the swing passage forms a sector contour; and a part of the sector contour being extended forward from the insertion passage by a range between 5 to 15 degrees, while a remaining part of the sector contour being extended backward from the insertion passage by a range between 90 to 100 degrees.

9. The drum pedal beater having switchable striking surfaces as claimed in claim 1, wherein the beater head further includes an adjusting gap located perpendicular to the swing passage to divide the beater head into a first clamping section and a second clamping section located at two opposite sides of the adjusting gap; and a compressing member being provided between the first and the second clamping section for changing the adjusting gap and the mounting space to different sizes.

10. The drum pedal beater having switchable striking surfaces as claimed in claim 9, wherein the beater head further includes a first insertion hole formed on the first clamping section to extend in parallel with the adjusting gap, and a second insertion hole formed on between the first and the second clamping section to extend perpendicular to the adjusting gap and communicate with the first insertion hole and the adjusting gap; and the compressing member including a nut disposed in the first insertion hole and a screw extended through the second insertion hole to mesh with the nut in the first insertion hole.
